(19) United States
(12) Patent Application Publication
(10) Pub. No.: US 2005/0238458 A1
(43) Pub. Date: Oct. 27, 2005

(54) System for fixing a commercial screw to the plastic support thereof

(75) Inventor: Joan Carreras, Valls (ES)

Correspondence Address: Bruce E. Harang, PO BOX 872735, VANCOUVER, WA, 98687-2735, US

(73) Assignee: Lear Corporation, Southfield, MI (US)

(21) Appl. No.: 10/709,256

(22) Filed: Apr. 24, 2004

(51) Int. Cl. F16B 37/02

(52) U.S. Cl. 411/172

(57) ABSTRACT

Specially conceived for the fixing of commercial screws to electrical distribution boxes as those used in automotive vehicles, it consists of a U-shaped metallic part (4), with the central branch thereof provided with a hole (5) for the passage of the threaded rod (2) of the screw and which side branches are spaced in accordance with the width of the head (3) of said screw, said side branches (6) of the metallic part being intended to couple under pressure into grooves (8) arranged on the plastic support or distribution box (1), for which said side branches (6) have their side edges provided with dentations (9) in the form of hooks which lock themselves onto the side edges of the grooves (8), immobilizing the metallic part (4) both in an angular direction and in an axial direction, and transferring said immobilization to the screw (2) through the head (3) thereof.

### BACKGROUND OF INVENTION

1. Field of the Invention

The present invention refers to a system for fixing a commercial screw to the corresponding plastic support thereof, which has been specially conceived to carry out the immobilization of the screw, both in an axial direction and in an angular direction.

The system of the invention is of special application in the scope of the automobile industry, especially in the manufacture of electrical distribution boxes for vehicles.

The object of the invention is to achieve a quick, secure and effective fixing of the screw to the complementary support thereof, which is maintained stable during the operation of fixing and tightening of the complementary nut, and obviously thereafter.

2. Object of the Invention

In the preferred scope of practical application of the invention, that of distribution boxes used in automotive vehicles, the use of screws, which must remain solidly tightened to the distribution box, is indispensable in order to subsequently fix different components of the circuit thereto, for example cables or others, with the aid of corresponding nuts.

Evidently, the use of commercial screws is the most desirable, being of lower cost than special screws, such that when screws on the market were used, the heads thereof were arranged on the body of the box during the molding phase thereof, a solution wherein the tightening of the screw on many occasions brought the tightening torque to cause the screw to come out from the corresponding housing thereof, and to consequently become useless as such a fixing means.

The use of special screws solves the problems previously set forth, but the cost thereof is clearly unsatisfactory.

### DESCRIPTION OF THE INVENTION

The fixing system proposed by the invention solves the problems previously set forth in an entirely satisfactory manner, such that it constitutes a cheap as well as fully effective solution.

To this end and more specifically, said system is based on the use of a U-shaped metallic part for each commercial screw, the central branch of the metallic part being provided with a hole of suitable shape and size for the passage of the threaded rod or portion of the screw, and the side branches of which are spaced so as to become adapted and to fix the head of said screw, with the special particularity that said side branches extend substantially beyond said head, as well as having toothed side edges defined in the form of hooks for the solid fixing thereof to the plastic support.

The system is completed with the existence on said plastic support, specifically in correspondence with the positioning area of each screw, of a pair of receiving grooves or inlets for the side branches of the metallic part, such that the dentations or hooks of the latter tightly penetrate into said grooves, finally remaining immobilized therewithin, both against the angular forces to which the screw is subjected during the assembly of the corresponding nut, and against the axial traction forces to which it may also be subjected as a result of the tightening of said nut.

### BRIEF DESCRIPTION OF DRAWINGS

To supplement the description being carried out and for the purpose of helping to better understand the features of the invention, according to a preferred practical embodiment thereof, a set of drawings is attached as an integral part of said description, wherein the following are represented with an illustrative and non-limiting character:

FIG. 1 shows an exploded perspective view of a screw and the corresponding plastic support thereof, according to the fixing system constituting the object of the present invention.

FIG. 2 shows a similar representation to the previous figure, in which the screw is suitably assembled on the plastic support.

### DETAILED DESCRIPTION

In the figures described, a distribution box (1) is represented as a plastic support for the screws, but evidently, the invention is applicable to any other type of box or to any other type of support of a plastic nature, provided that this meets the determining factors which will be discussed below.

The system is intended to allow the use of commercial screws with the classic threaded rod (2) thereof finished in a polygonal head (3), such as for example in a hexagonal prismatic or quadrangular prismatic head, which are the most common on the market.

That said, the system of the invention is materialized in a U-shaped metallic part (4), on which central branch, corresponding to the same reference number (4), a hole (5) appears in a central position and of suitable size to allow the passage of the threaded rod (2) of the screw therethrough, whilst the side branches (6) of the metallic part are spaced in correspondence with the spacing of the two parallel or opposite sides of the head (3) of the screw, which thus remains immobilized in an angular direction in the centre of the metallic part (4).

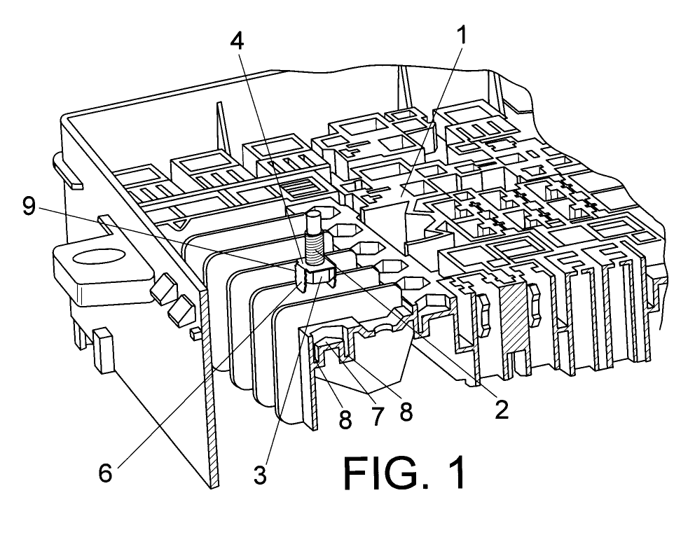

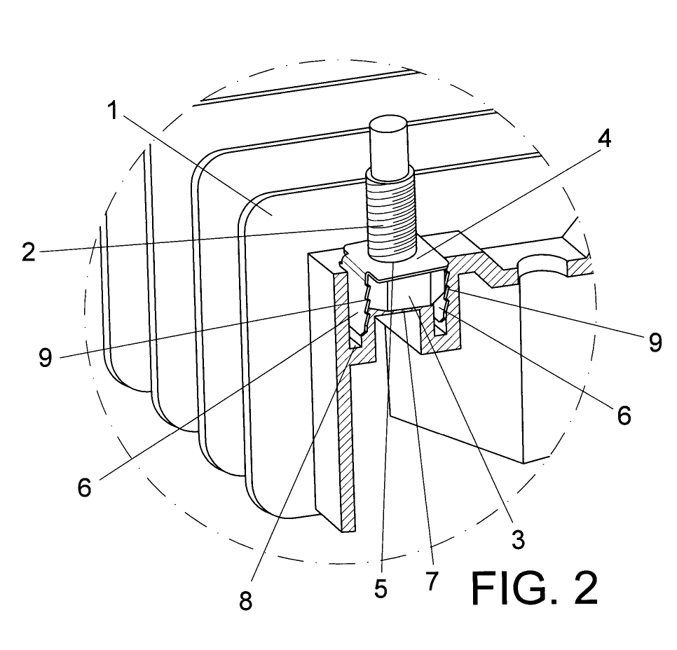

Complimentarily on the plastic support (1), on the distribution box in the practical embodiment chosen in the figures, a recess (7), especially visible in FIG. 1, is arranged in correspondence with each point intended for the insertion of a screw (2-3), said recess having a suitable shape and size so as to receive the head (3) of the screw, and from the bottom of which a pair of parallel grooves (8) project, in turn having a suitable shape, size and position so as to receive the side branches (6) of the U-shaped metallic part (4), as can in turn be observed in FIG. 2, such that these grooves (8) collaborate in the immobilization of the screw (2-3) in an angular direction.

As a complement to the structure described, the edges of the side branches (6) of the metallic part (4) incorporate dentations (9) in the form of hooks which, facilitating the introduction of the side branches (6) in the grooves (8), tend to lock themselves onto the sides of the latter with a tractive force on said metallic part (4), which in turn immobilizes the screw (2-3) in an axial direction, i.e. against tractive forces thereon, a complementary immobilization to the aforementioned one, i.e. that of immobilization in an angular or in a twisting direction.

A solid fixing of the screw to the support is thus achieved with the simple help of the U-shaped metallic part (4) which, due to its own nature and shape, has a minimum impact on the cost of immobilizing the screw to the support, ensuring a solid and effective fixing therefor.

1-9. (canceled)

10. A device for fixedly attaching a bolt to a power distribution box for use in an automobile comprising:
a metallic part having a generally U-shape comprising a pair of legs joined by a cross member, said cross member having a hole for accepting the threaded portion of a bolt having a threaded portion and an bolt head portion, and each of said legs of said U-shape metallic part engaging a flat face of said bolt head;
thereby fixedly attaching said bolt and said metallic part to said power distribution box.

11. A device for fixedly attaching a bolt to a power distribution box for use in an automobile as claimed in claim 7 wherein, said metallic part has legs that have a length substantially longer than the thickness of said bolt head; thereby allowing fixedly mounting to said power distribution box.

12. A device for fixedly attaching a bolt to a power distribution box for use in an automobile as claimed in claim 8 wherein, said legs have a plurality of dentations positioned to engage said power distribution box.
